(19) United States
(12) Patent Application Publication
(10) Pub. No.: US 2007/0137748 A1
(43) Pub. Date: Jun. 21, 2007

(54) Pneumatic radial tire for airplanes

(75) Inventor: Seiji Itai, Tachikawa-shi (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 11/634,094

(22) Filed: Dec. 6, 2006

(30) Foreign Application Priority Data
Dec. 21, 2005 (JP) 2005-368276

(51) Int. Cl. B60C 11/00

(52) U.S. Cl. 152/209.14; 152/527; 152/538

(57) ABSTRACT

A pneumatic radial tire for an airplane comprises a pair of bead cores, a carcass comprised of at least one carcass ply, a main belt comprised of at least two belt layers, an auxiliary belt comprised of plural layers, and a tread, wherein the main belt has a lamination thickness satisfying 0.2≦G₁/G₀≦0.8 as a relation between a lamination thickness at the widthwise center of the tire (G₀) and a lamination thickness at a position corresponding to ⅔ of a maximum width (G₁), and the tread satisfies 0.85≦D_{S}/D_{C}≦1.1 as a relation between a tread thickness at a widthwise center position of the tire (D_{C}) and a tread thickness at a position of a width corresponding to 80% of a maximum width of the main belt (D_{S}), and has a radius of curvature on an outer surface of the tread formed by filling a normal internal pressure satisfying 0.4≦R₂/R₁≦3.0 as a relation between a radius of curvature in a central region including the widthwise center of the tire (R₁) and a radius of curvature forming a widthwise side region outward from the central region (R₂) being connected to each other at a position corresponding to 40-60% of the maximum width of the main belt.

### BACKGROUND OF THE INVENTION

1. Field of the Invention

This invention relates to a pneumatic radial tire for an airplane, and more particularly to an airplane tire having a higher durability by improving the resistance to uneven wear of the tire.

2. Description of the Related Art

As one of performances required in the radial tire for the airplane is mentioned a force resisting to foreign matter, i.e. a cut-resistant durability. In the airplane tire, it is a very important issue to improve the cut-resistant durability because there is a serious problem that the burst or peel-off may be caused by riding on the foreign matter and finally an airframe is damaged by the broken pieces of the tire.

As a large design element for improving the cut-resistant durability, there is always known that it is particularly useful to suppress the size growth of the tire.

Recently, it is a proposition in airframe makers to conduct the weight reduction of the airframe as far as possible for reducing the fuel consumption of the airplane, and hence the weight reduction of the tire is more severely required in tire makers.

It is very difficult to satisfy such a requirement by the conventional technique, so that it is demanded to develop tires by using a new technique.

There are developed tires in which Kevlar cords having a higher strength are used instead of nylon cords being a mainstream in the airplane tire for suppressing the size growth and decreasing the number of belt layers (see, for example, WO 2003/061991). Further, it becomes clear from the recent examination results that a tire provided with a main belt having a structure that a belt cord is spirally and continuously wound at an angle of approximately 0° with respect to a rotating direction of the tire from a winding start to a winding end and a gauge distribution is made smaller from a central portion toward a belt end portion (hereinafter referred to as a convex structure) is effective as a new technique capable of realizing the weight reduction of the tire (particularly weight reduction of a shoulder portion) while more suppressing the size growth.

In the tire using the Kevlar cord, however, there is a limit in the improving effect. In the tire provided with the main belt of the convex structure, it is an actual state that a ground contacting shape (foot print) formed by pushing the tire onto a flat plate under a normal internal pressure and a normal load becomes not favorable.

In order to render the ground contacting shape into a rectangular form, it is generally effective to make an outer surface of a tread flat to make small a size difference between the central portion and the shoulder portion in the tire, whereby an adequate rectangle ratio can be obtained. In the tire provided with the main belt of the convex structure, however, the number of belt layers is less in the shoulder portion than in the central portion (the rigidity in the circumferential direction of the belt is smaller in the shoulder portion than in the central portion), so that if the outer surface of the tread is made flat, the belt is stretched in the shoulder portion to make long the ground contacting length and hence the ground contacting shape becomes rendered into a butterfly form. Such a ground contacting shape brings about the heat generation at the shoulder rib during the running, which results in a large deterioration of high-speed durability.

In order to avoid the formation of the butterfly type ground contacting shape and suppress the size growth of the tire, it is effective to make a crown shape provided on the outer surface of the tread smaller than that of the conventional structure, whereby a global rectangle ratio (ground contacting length of shoulder rib/ground contacting length of center rib) can be rendered into a target value. However, even if a small crown form is simply provided, a local rectangle ratio (ratio of ground contacting length of outside to inside in the shoulder rib) becomes small, so that the ground contacting shape becomes inadequate at a ground contacting end portion of the tire and there is a fear of causing the uneven wear at the shoulder rib.

### SUMMARY OF THE INVENTION

It is, therefore, an object of the invention to solve the above conventional problems and to propose a novel radial tire for an airplane capable of improving the resistance to uneven wear to enhance the tire durability.

According to the invention, there is the provision of a pneumatic radial tire for an airplane comprising a pair of bead cores, a carcass comprised of at least one carcass ply toroidally extending between the pair of the bead cores, a main belt disposed on a radially outer peripheral face of a crown portion of the carcass and comprised of at least two belt layers each being formed by spirally winding a rubberized inextensible high-rigidity cord(s), an auxiliary belt comprised of plural layers each being formed by bending a ribbon-shaped treat of rubberized nylon cords on a same plane in opposite directions between both ends and zigzag extending in a circumferential direction, and a tread disposed on a radially outside of the auxiliary belt, wherein the main belt has a lamination thickness gradually decreasing from a widthwise center of the tire toward an end portion thereof and satisfies a condition of 0.2≦G₁/G₀≦0.8 when a lamination thickness at the widthwise center of the tire is G₀ and a lamination thickness at a position corresponding to ⅔ of a maximum width is G₁; and

the tread satisfies a condition of 0.85≦D_{S}/D_{C}≦1.1 when a tread thickness at a widthwise center position of the tire is D_{C} and a tread thickness at a position of a width corresponding to 80% of a maximum width of the main belt is D_{S}; and

an outer surface of the tread formed by filling a normal internal pressure has a radius of curvature satisfying a condition of 0.4≦R₂/R₁≦3.0 when a radius of curvature in a central region including the widthwise center of the tire is R₁ and a radius of curvature forming a widthwise side region outward from the central region is R₂, and the radius of curvature R₁ and the radius of curvature R₂ are connected to each other at a position corresponding to 40-60% of the maximum width of the main belt.

In the pneumatic radial tire for the airplane having the above construction, it is particularly preferable that the main belt includes organic fiber cords and the organic fiber cord has a tensile strength at break of not less than 6.3 cN/dtex and an elongation ratio of 0.2-2.0% when a load of 0.3 cN/dtex is applied in a stretching direction, an elongation ratio of 1.5-7.0% when a load of 2.1 cN/dtex is applied in a stretching direction and an elongation ratio of 2.2-9.3% when a load of 3.2 cN/dtex is applied in a stretching direction.

Also, it is preferable that the tread comprises land portions defined by a plurality of main groove in a rotating direction of the tire and has a ground contacting face formed on a flat plate under a normal internal pressure and a normal load satisfying conditions of 0.8≦B/A≦1.05 and 0.9≦B₀/B₁≦1.1 when a length at the widthwise center of the tire is A and a length at a position corresponding to 84% of a ground contacting width is B and a length at a position corresponding to 88% of a ground contacting width is B₀ and a length at a widthwise innermost side of an outermost land portion is B₁ and B/A is a global rectangle ratio and B₀/B₁ is a local rectangle ratio. At this moment, the normal internal pressure and the normal load mean an internal pressure and a load defined in TRA standard.

According to the invention, the main belt has a lamination thickness gradually decreasing from a widthwise center of the tire toward an end portion thereof and satisfies a condition of 0.2≦G₁/G₀≦0.8 when a lamination thickness at the widthwise center of the tire is G₀ and a lamination thickness at a position corresponding to ⅔ of a maximum width is G₁; and the tread satisfies a condition of 0.85≦D_{S}/D_{C}≦1.1 when a tread thickness at a widthwise center position of the tire is D_{C} and a tread thickness at a position of a width corresponding to 80% of a maximum width of the main belt is D_{S}; and an outer surface of the tread formed by filling a normal internal pressure has a radius of curvature satisfying a condition of 0.4≦R₂/R₁≦3.0 when a radius of curvature in a central region including the widthwise center of the tire is R₁ and a radius of curvature forming a widthwise side region outward from the central region is R₂, and the radius of curvature R₁ and the radius of curvature R₂ are connected to each other at a position corresponding to 40-60% of the maximum width of the main belt, so that the ground contacting length in the widthwise direction of the tire becomes approximately the same and the slippage of tread rubber at the shoulder rib becomes small (i.e. work volume due to wearing can be made small), and hence the uneven wear of the shoulder portion is suppressed.

### BRIEF DESCRIPTION OF THE DRAWINGS

The invention will be described in detail with reference to the accompanying drawings, wherein:

FIG. 1 is a right-half section view of a pneumatic radial tire for an airplane according to an embodiment of the invention;

FIG. 2 is a right-half section view of a pneumatic radial tire for an airplane according to an embodiment of the invention;

FIG. 3 is a schematic view illustrating a shape of a ground contacting face in a pneumatic radial tire for an airplane according to an embodiment of the invention; and

FIG. 4 is a schematic view illustrating a shape of a ground contacting face in a pneumatic radial tire for an airplane according to an embodiment of the invention.

### DETAILED DESCRIPTION OF THE INVENTION

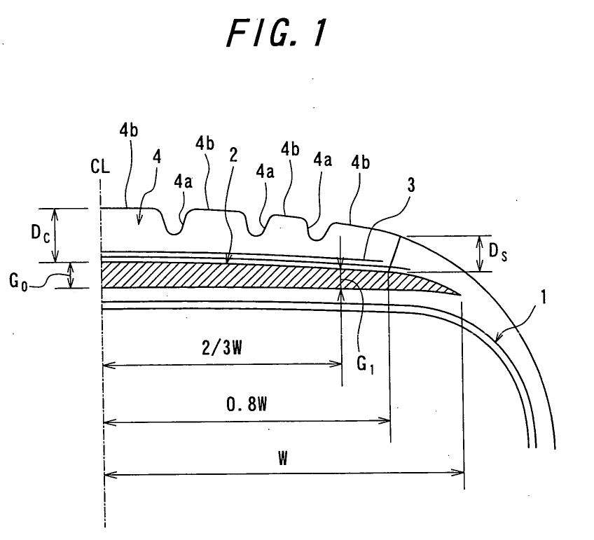

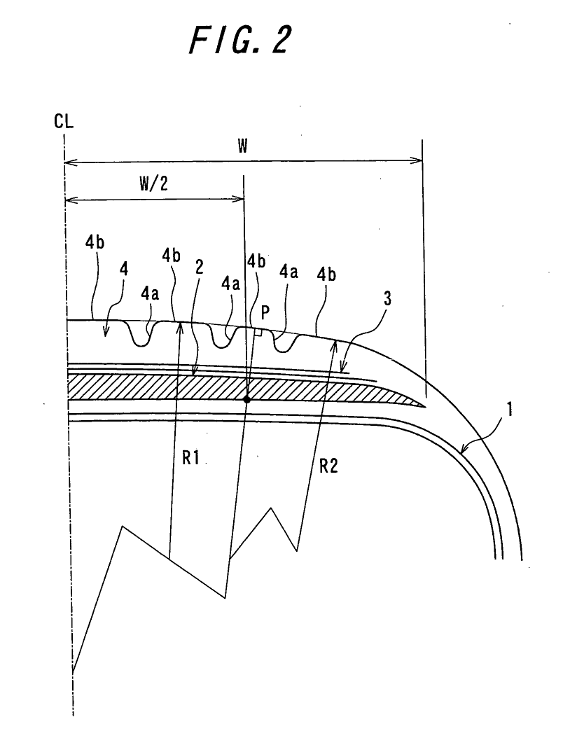

In FIGS. 1 and 2 is shown a right-half part of an embodiment of the pneumatic radial tire for an airplane according to the invention.

In these figures, numeral 1 is a carcass comprised of at least one carcass ply toroidally extending between a pair of bead cores (not shown), and numeral 2 is a main belt disposed on a crown portion radially outer peripheral face of a crown portion of the carcass 1. The main belt 2 may be comprised of at least two belt layers formed by spirally winding a rubberized inextensible high-rigidity cord(s) (Kevlar cord may be applied).

Also, numeral 3 is an auxiliary belt comprised of plural layers each being formed by bending a ribbon-shaped treat of rubberized nylon cords on a same plane in opposite directions between both ends and zigzag extending in a circumferential direction, and a tread disposed on a radially outside of the auxiliary belt and disposed on a radially outside of the main belt 2, and numeral 4 is a tread disposed on a radially outside of the auxiliary belt 3. The tread 4 is provided on its outer surface with a plurality of main grooves 4a formed in a rotating direction of the tire and defining plural land portions (ribs) 4b.

The main belt 2 has a lamination thickness gradually decreasing from a widthwise center of the tire toward an end portion thereof and satisfies a condition of 0.2≦G₁/G₀≦0.8 when a lamination thickness at the widthwise center of the tire is G₀ and a lamination thickness at a position corresponding to ⅔ of a maximum width (width ranging from the widthwise center position of the tire to an end portion thereof) is G₁ as shown in FIG. 1.

Also, the tread 4 satisfies a condition of 0.85≦D_{S}/D_{C}≦1.1 when a tread thickness at a widthwise center position of the tire is D_{C} and a tread thickness at a position of a width corresponding to 80% of a maximum width of the main belt 2 is D_{S}, and the outer surface of the tread 4 formed by filling a normal internal pressure has a radius of curvature satisfying a condition of 0.4≦R₂/R₁≦3.0 when a radius of curvature in a central region including the widthwise center of the tire is R₁ and a radius of curvature forming a widthwise side region outward from the central region is R₂, and the radius of curvature R₁ and the radius of curvature R₂ are connected to each other at a position corresponding to 40-60% of the maximum width of the main belt 2.

In the invention, the reason why the relation between the lamination thickness at the widthwise center of the tire (G₀) and the lamination thickness at a position corresponding to ⅔ of a maximum width (G₁) is 0.2≦G₁/G₀≦0.8 is due to the fact that when G₁/G₀ is less than 0.2, an excessive tension is applied to the belt layer located in the vicinity of the shoulder portion and hence there is caused a fear of deteriorating the resistance to pressure, while when it exceeds 0.8, the belt layer located at the position corresponding to ⅔ of the maximum width is not effectively utilized, which may lead to increase the weight of the pneumatic radial tire.

Also, the reason why the relation between the tread thickness at a widthwise center position of the tire (D_{c}) and the tread thickness at a position of a width corresponding to 80% of a maximum width of the main belt (Dₛ) is limited to 0.85≦D_{S}/D_{C}≦1.1 is due to the fact that when D_{S}/D_{C} is less than 0.85, the ground contacting shape becomes not rectangular but becomes rounded, while when it exceeds 1.1, the ground contacting shape becomes butterfly type.

In the outer surface of the tread formed by filling a normal internal pressure, when the relation between the radius of curvature in a central region including the widthwise center of the tire (R₁) and the radius of curvature forming a widthwise side region outward from the central region (R₂) is 0.4≦R₂/R₁≦3.0 and the radius of curvature R₁ and the radius of curvature R₂ are connected to each other at a position corresponding to 40-60% of the maximum width of the main belt, the adequate ground contacting shape can be obtained.

The radius of curvature (R₂) is smoothly connected to the radius of curvature (R₁) at a tangent point P located in a region corresponding to 40-60% of the maximum width of the main belt 2.

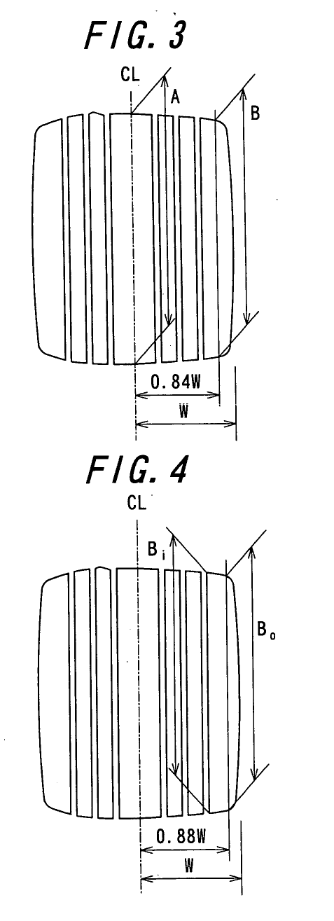

In FIGS. 3 and 4 is shown a shape of a ground contacting face on a flat plate under a normal internal pressure and a normal load with respect to the pneumatic radial tire for an airplane according to the invention, respectively.

In the invention, the reason why the relation among the length (A) at the widthwise center of the tire, the length (B) at a position corresponding to 84% of the ground contacting width (W), the length (B₀) at a position corresponding to 88% of the ground contacting width (W) and the length (B₁) at the widthwise innermost side of the outermost land portion is 0.8≦B/A≦1.05 and 0.9≦B₀/B₁≦1.1 is due to the following reasons.

When B/A is less than 0.8, the uneven wear can not be avoided, while when it exceeds 1.05, the heat generation in the shoulder portion becomes large and troubles resulted therefrom is easily caused.

Also, when B₀/B₁ is less than 0.9, the uneven wear (shoulder wear) is caused in the land portion (rib) at the shoulder region and hence the groove located at the shoulder region is worn prematurely (leading to premature exchange of tire), while when it exceeds 1.1, the heat generation becomes large in the rib at the shoulder region, and hence the tread is blown out in the takeoff test under a high loading but also the ground contacting pressure becomes too high to considerably promote the wearing.

The main belt 2 may be constructed with organic fiber cords in which the organic fiber cord has a tensile strength at break of not less than 6.3 cN/dtex and an elongation ratio of 0.2-2.0% when a load of 0.3 cN/dtex is applied in a stretching direction, an elongation ratio of 1.5-7.0% when a load of 2.1 cN/dtex is applied in a stretching direction and an elongation ratio of 2.2-9.3% when a load of 3.2 cN/dtex is applied in a stretching direction. In this case, the suppression of the size growth to be targeted can be easily attained, whereby the resistance to the sticking of foreign matter is ensured and the hoop effect of the main belt 2 is optimized.

As the organic fiber cord used in the carcass ply constituting the carcass 1 and the organic fiber cord constituting the main belt 2 are applied aromatic polyamide fibers.

### EXAMPLE

There are provided tires having a tire size of 1400×530R23 40PR and a structure shown in Table 1, respectively, which are then subjected to a high-speed durable test and also the wearing state at the rib in the shoulder region is examined. The results are shown in Table 1.

Moreover, the high-speed durable test is carried out by repeating a drum test, in which the running of the tire is accelerated to a speed of 380 km/h under a normal internal pressure and a normal load in about 1 minutes, several ten times and the number of high-speed durable drum tests is represented by an index on the basis that a standard tire is 100. On the other hand, the wearing state at the rib in the shoulder region is evaluated by measuring a work volume due to wearing in the shoulder rib, and the measured value is represented as a coefficient of resistance to uneven wear by an index on the basis that the standard tire is 100. Further, the size growth of the tire is represented by a ratio of an outer diameter of the tire filled under a normal internal pressure to an outer diameter of the tire before the filling of the internal pressure (free state).

TABLE 1

| | | Acceptable | Comparative | Comparative | Comparative | Standard |
|---|---|---|---|---|---|---|
| | | Example | Example 1 | Example 2 | Example 3 | tire |
| Carcass | ply | 7 | 7 | 7 | 7 | 7 |
| | number | | | | | |
| | kind of | nylon | nylon | nylon | nylon | nylon |
| | cord | | | | | |
| Auxiliary | type | zigzag | zigzag | zigzag | zigzag | zigzag |
| belt | kind of | nylon | nylon | nylon | nylon | nylon |
| | cord | | | | | |
| | cord angle | 80 | 80 | 80 | 80 | 80 |
| | (°) | | | | | |
| | number of | 2 | 2 | 2 | 2 | 2 |
| | layers | | | | | |
| | belt width | 0.9 | 0.9 | 0.9 | 0.9 | 0.9 |
| Main | kind of | Kevlar | Kevlar | Kevlar | Kevlar | Kevlar |
| belt | cord | | | | | |
| | belt | spiral | spiral | spiral | spiral | spiral |
| | shaping | | | | | |
| | method | | | | | |
| | belt | convex | convex | convex | convex | convex |
| | structure | | | | | |
| G₁/G₀ | | 0.57 | 0.57 | 0.57 | 0.57 | 0.57 |
| Dₛ/D_{c} | | 0.90 | 0.90 | 0.82 | 1.14 | 0.90 |
| R₂/R₁ | | 1.2 | 3.4 | 0.56 | 0.56 | 0.35 |
| B/A (global rectangle | | 0.93 | 0.93 | 0.88 | 1.12 | 0.89 |
| ratio) | | | | | | |
| B₀/B₁ (local rectangle | | 1.01 | 1.15 | 0.89 | 1.12 | 0.89 |
| ratio) | | | | | | |
| Test | size | 1.5 | 1.5 | 1.5 | 1.5 | 1.5 |
| items | growth | | | | | |
| | (%) | | | | | |
| | number of | 102 | 84 | 101 | 91 | 100 |
| | high- | | | | | |
| | speed | | | | | |
| | durable | | | | | |
| | drum tests | | | | | |
| | (index) | | | | | |
| | coefficient | 110 | 98 | 98 | 103 | 100 |
| | of | | | | | |
| | resistance | | | | | |
| | to uneven | | | | | |
| | wear at | | | | | |
| | shoulder | | | | | |
| | rib (index) | | | | | |

As seen from the results of Table 1 based on the standard tire, all of the size growth, durability and resistance to uneven wear are improved in the tire according to the invention (acceptable example) as compared with the tires of Comparative Examples 1-3.

According to the invention, there can be provided radial tires for airplanes having an improved resistance to uneven wear and a high durability.

What is claimed is:

1. A pneumatic radial tire for an airplane comprising a pair of bead cores, a carcass comprised of at least one carcass ply toroidally extending between the pair of the bead cores, a main belt disposed on a radially outer peripheral face of a crown portion of the carcass and comprised of at least two belt layers each being formed by spirally winding a rubberized inextensible high-rigidity cord(s), an auxiliary belt comprised of plural layers each being formed by bending a ribbon-shaped treat of rubberized nylon cords on a same plane in opposite directions between both ends and zigzag extending in a circumferential direction, and a tread disposed on a radially outside of the auxiliary belt, wherein the main belt has a lamination thickness gradually decreasing from a widthwise center of the tire toward an end portion thereof and satisfies a condition of 0.2≦G₁/G₀≦0.8 when a lamination thickness at the widthwise center of the tire is G₀ and a lamination thickness at a position corresponding to ⅔ of a maximum width is G₁; and
the tread satisfies a condition of 0.85≦D_{S}/D_{C}≦1.1 when a tread thickness at a widthwise center position of the tire is D_{C} and a tread thickness at a position of a width corresponding to 80% of a maximum width of the main belt is D_{S}; and
an outer surface of the tread formed by filling a normal internal pressure has a radius of curvature satisfying a condition of 0.4≦R₂/R₁≦3.0 when a radius of curvature in a central region including the widthwise center of the tire is R₁ and a radius of curvature forming a widthwise side region outward from the central region is R₂, and the radius of curvature R₁ and the radius of curvature R₂ are connected to each other at a position corresponding to 40-60% of the maximum width of the main belt.

2. A pneumatic radial tire for an airplane according to claim 1, wherein the main belt includes organic fiber cords and the organic fiber cord has a tensile strength at break of not less than 6.3 cN/dtex and an elongation ratio of 0.2-2.0% when a load of 0.3 cN/dtex is applied in a stretching direction, an elongation ratio of 1.5-7.0% when a load of 2.1 cN/dtex is applied in a stretching direction and an elongation ratio of 2.2-9.3% when a load of 3.2 cN/dtex is applied in a stretching direction.

3. A pneumatic radial tire for an airplane according to claim 1 or 2, wherein the tread comprises land portions defined by a plurality of main groove in a rotating direction of the tire and has a ground contacting face formed on a flat plate under a normal internal pressure and a normal load satisfying conditions of 0.8≦B/A≦1.05 and 0.9≦B₀/B₁≦1.1 when a length at the widthwise center of the tire is A and a length at a position corresponding to 84% of a ground contacting width is B and a length at a position corresponding to 88% of a ground contacting width is B₀ and a length at a widthwise innermost side of an outermost land portion is B₁ and B/A is a global rectangle ratio and B₀/B₁ is a local rectangle ratio. At this moment, the normal internal pressure and the normal load mean an internal pressure and a load defined in TRA standard.
